(19) United States
(12) Patent Application Publication
(10) Pub. No.: US 2025/0044110 A1
(43) Pub. Date: Feb. 6, 2025

(54) NAVIGATION SYSTEM FOR HIGHLIGHTING A TARGET LOCATION OF A DESTINATION BY INFRARED LIGHT

(71) Applicant: GM Global Technology Operations LLC, Detroit, MI (US)

(72) Inventors: Aaron David Greer, St. Clair Shores, MI (US); Joseph F. Szczerba, Grand Blanc, MI (US); Maureen Elizabeth August, Gross Pointe Woods, MI (US)

(21) Appl. No.: 18/363,204

(22) Filed: Aug. 1, 2023

(51) Int. Cl. G01C 21/36; B60K 35/28; B60W 50/14

(52) U.S. Cl. CPC G01C 21/3602; B60K 35/28; B60W 50/14; G01C 21/362; G01C 21/3647; B60K 2360/176; B60K 2360/566; B60K 2360/589; B60W 2050/146; B60W 2420/403; B60W 2540/21; B60W 2540/215; B60W 2556/50

(57) ABSTRACT

A navigation system for a vehicle that highlights a target location that is part of a destination includes a spotlight device that generates a beam of infrared light to create an infrared spotlight, an infrared camera that captures infrared image data, a display, and one or more controllers in electronic communication with the spotlight device, the infrared camera, and the display. In response to determining the vehicle is approaching the destination, the one or more controllers calculate a target angle indicating where the spotlight device directs the beam of infrared light to create the infrared spotlight upon the target location. The one or more controllers receive the infrared image data captured by the one or more infrared cameras of the target location of the destination and instructs the display to show the infrared image data captured by the one or more infrared cameras.

### INTRODUCTION

The present disclosure relates to a navigation system for a vehicle that highlights a target location that is part of a destination by infrared light.

A global navigation satellite system (GNSS) is a satellite constellation that broadcasts positioning, navigation, and timing (PNT) data on a global or regional basis. Drivers may rely upon a GNSS system to provide directions to locations such as, for example, a residence, an office building, a commercial venue such as a store, or an event venue such as a stadium. A driver may provide a street address or location coordinates, such as military grid reference system (MGRS) or global positioning system (GPS) coordinates, which indicate the specific location of a destination. The GNSS may then instruct the driver to the location associated with the street address.

Street addresses are sometimes problematic because a single street address may have multiple destinations, which makes it difficult for a driver to determine the exact intended location of the end destination. Specifically, for example, a street address representing an industrial building may include several bay doors for picking up or dropping off packages, or a stadium having multiple entrances. As another example, when delivering or picking up packages, there may be multiple locations where the package may be found, such as doorways, mailboxes, drop-boxes, and the like, which may create multiple options to delivering personnel. Furthermore, commercial ride-share drivers or taxicab drivers may find it difficult to locate the individual they are attempting to pick up at a crowded venue. It is also difficult to verify the identity of the individuals that requested the ride as well as the ride-share driver other than by name and license plate of the vehicle of the ride-share driver.

Thus, while navigation systems for vehicles achieve their intended purpose, there is a need in the art for an improved approach to assist a driver in highlighting a specific location that is part of a destination.

### SUMMARY

According to several aspects, a navigation system for a vehicle that highlights a target location that is part of a destination is disclosed. The navigation system includes a spotlight device that generates a beam of infrared light to create an infrared spotlight, one or more infrared cameras that capture infrared image data representative of the target location of the destination, a display that renders images upon a screen, and one or more controllers in electronic communication with the spotlight device, the infrared camera, and the display. The one or more controllers execute instructions to determine the vehicle is approaching the destination, and in response to determining the vehicle is approaching the destination, calculate a target angle indicating where the spotlight device directs the beam of infrared light to create the infrared spotlight upon the target location. The one or more controllers receive the infrared image data captured by the one or more infrared cameras of the target location of the destination, where the infrared image data includes the infrared spotlight, and instruct the display to show the infrared image data captured by the one or more infrared cameras.

In an aspect, the navigation system further comprises a user input device in electronic communication with the one or more controllers, where the user input device receives user input generated by an occupant of the vehicle.

In another aspect, the user input indicates the destination, and wherein the one or more controllers determine the target location of the destination.

In yet another aspect, the one or more controllers determine an exact position of the target location of the destination based on a description of the destination and the image data captured by the one or more visible light cameras representing the destination.

In an aspect, the navigation system further comprises one or more visible light cameras in electronic communication with the one or more controllers, where the one or more visible light cameras capture image data representative of the target location of the destination, and where the one or more controllers determine the exact position of the target location of the destination based on the image data captured by the one or more visible light cameras representing the destination.

In another aspect, the user input device is one of the following: a touchscreen, a keyboard, or an audio receiver that captures voice commands spoken by an occupant of the vehicle.

In yet another aspect, the target angle represents an angle measured between a direction of travel of the vehicle and the target location of the destination.

In an aspect, a vehicle heading angle is measured between the direction of travel of the vehicle and the North, a true bearing angle is measured between the North and the target location, and the target angle represents a difference between the true bearing angle and the vehicle heading angle.

In another aspect, the navigation system further comprises a global navigation satellite system (GNSS) in electronic communication with the one or more controllers, wherein the GNSS provides location data.

In yet another aspect, the one or more controllers execute instructions to continuously monitor the location data provided by the GNSS to determine a current location of the vehicle, compare the current location of the vehicle with the destination, and in response to determining the current location of the vehicle is within a threshold distance from the destination, the one or more controllers determine the vehicle is approaching the destination.

In an aspect, the spotlight device is one of the following: a motorized pivoting infrared spotlight, a fixed-position matrix spotlight including a plurality of infrared light-emitting diodes (LEDs), and LiDAR.

In another aspect, the destination is represented by one of the following: a street address and location coordinates.

In yet another aspect, the one or more controllers are in wireless communication with a personal electronic device associated with an occupant of the vehicle.

In an aspect, the target location of the destination is shown upon a display of the personal electronic device.

In another aspect, a method for highlighting a target location of a destination by an infrared spotlight by a navigation system for a vehicle is disclosed. The method includes determining, by one or more controllers, the vehicle is approaching the destination. In response to determining the vehicle is approaching the destination, calculating, the method includes by the one or more controllers, a target angle indicating where a spotlight device directs a beam of infrared light to create an infrared spotlight upon the target location. The method includes receiving, by the one or more controllers, infrared image data captured by one or more infrared cameras of the target location of the destination, where the infrared image data includes the infrared spotlight. The method includes instructing, by the one or more controllers, a display to show the infrared image data captured by the one or more infrared cameras.

In yet another aspect, a navigation system for a vehicle that highlights a target location that is part of a destination is disclosed. The navigation system includes a spotlight device that generates a beam of infrared light to create an infrared spotlight, one or more infrared cameras that capture infrared image data representative of the target location of the destination, a display that renders images upon a screen, and one or more controllers in electronic communication with the spotlight device, the infrared camera, and the display. The one or more controllers execute instructions to determine the vehicle is approaching the destination. In response to determining the vehicle is approaching the destination, the one or more controllers calculate a target angle indicating where the spotlight device directs the beam of infrared light to create the infrared spotlight upon the target location, where the target angle represents an angle measured between a direction of travel of the vehicle and the target location of the destination. The one or more controllers receive the infrared image data captured by the one or more infrared cameras of the target location of the destination, where the infrared image data includes the infrared spotlight. Finally, the one or more controllers instruct the display to show the infrared image data captured by the one or more infrared cameras.

In another aspect, the navigation system further comprises a user input device in electronic communication with the one or more controllers, wherein the user input device receives user input generated by an occupant of the vehicle.

In yet another aspect, the user input indicates the destination, and wherein the one or more controllers determine the target location of the destination.

In an aspect, the one or more controllers determine an exact position of the target location of the destination based on a description of the destination and the image data captured by the one or more visible light cameras representing the destination.

In another aspect, the navigation system further comprises one or more visible light cameras in electronic communication with the one or more controllers, where the one or more visible light cameras capture image data representative of the target location of the destination, and where the one or more controllers determine the exact position of the target location of the destination based on the image data captured by the one or more visible light cameras representing the destination.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle including the disclosed navigation system including one or more controllers in electronic communication with an spotlight device, a global navigation satellite system (GNSS), an infrared camera, and a display, according to an exemplary embodiment;

FIG. 2A illustrates an embodiment of a target location that is part of a destination, where the target location is a bay door of an industrial building, according to an exemplary embodiment;

FIG. 2B illustrates another embodiment of the target location that is part of the destination where the target location is a specific location of an individual standing outside an event venue, according to an exemplary embodiment;

FIG. 3 is a schematic diagram of a target angle indicating where the spotlight device directs a beam of infrared light to create an infrared spotlight upon the target location, according to an exemplary embodiment;

FIG. 4 illustrates a personal electronic device that displays the infrared spotlight, according to an exemplary embodiment; and

FIG. 5 is a process flow diagram illustrating a method for highlighting the target location of the destination by the infrared spotlight, according to an exemplary embodiment.

### DETAILED DESCRIPTION

The following description is merely exemplary in nature and is not intended to limit the present disclosure, application, or uses.

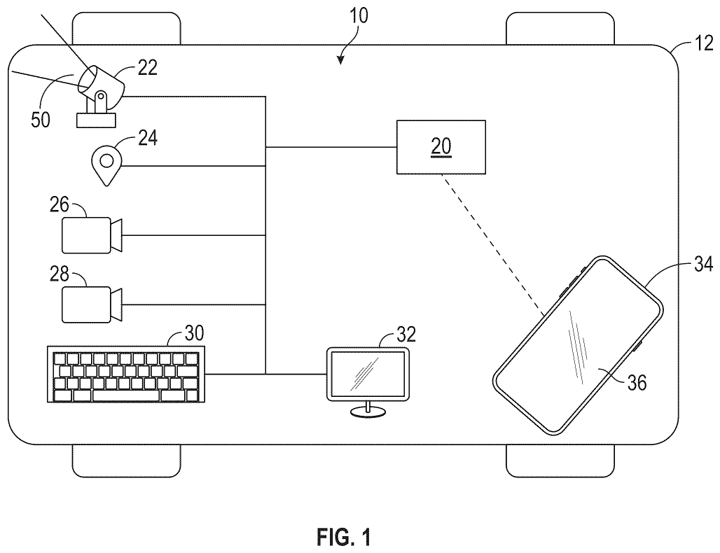

Referring to FIG. 1, a schematic diagram of an exemplary navigation system 10 for a vehicle 12 is illustrated. It is to be appreciated that the vehicle 12 may be any type of vehicle such as, but not limited to, a sedan, truck, sport utility vehicle, van, or motor home. The navigation system 10 includes one or more controllers 20 in electronic communication with a spotlight device 22, a global navigation satellite system (GNSS) 24 for providing location data, an infrared camera 26, a visible light camera 28, a user input device 30, and a display 32. In an embodiment, the one or more controllers 20 of the navigation system 10 is in wireless communication with a personal electronic device 34 associated with an occupant of the vehicle 12. The personal electronic device 34 represents any type of electronic device that is sized to be portable and carried by the occupant of the vehicle 12 such as, for example, a smartphone or tablet. The personal electronic device 34 includes a display 36 for presenting images and graphics to the occupant of the vehicle 12. It is to be appreciated that the visible light camera 28 is optional and may be omitted in embodiments.

The spotlight device 22 represents a device that generates a beam of infrared light to create an infrared spotlight 50 that illuminates a surface. The spotlight device 22 is any type of device that generates an infrared beam of light that creates the infrared spotlight 50 such as, for example, a motorized pivoting infrared spotlight, a fixed-position matrix spotlight including a plurality of infrared light-emitting diodes (LEDs), and LiDAR. The infrared camera 26 captures infrared image data representative of the environment surrounding the vehicle 12, while the visible light camera 28 captures image data representative of the environment surrounding the vehicle 12. The user input device 30 represents any device for receiving user input generated by an occupant of the vehicle 12 such as, for example, a touchscreen, a keyboard, or an audio receiver that captures voice commands spoken by an occupant. The display 32 is any device that renders images upon a screen such as, for example, an LED display.

The one or more controllers 20 receive an input indicating a destination of the vehicle 12. In one embodiment, the occupant of the vehicle 12 enters a destination into the navigation system 10 by the user input device 30, where the destination is represented by a street address or location coordinates, such as military grid reference system (MGRS) or global positioning system (GPS) coordinates. In another embodiment, the one or more controllers 20 receive the destination via the personal electronic device 34. For example, in one embodiment, the vehicle 12 is a ride-share vehicle that receives a destination via a ride-sharing application that is installed on a smartphone of the occupant.

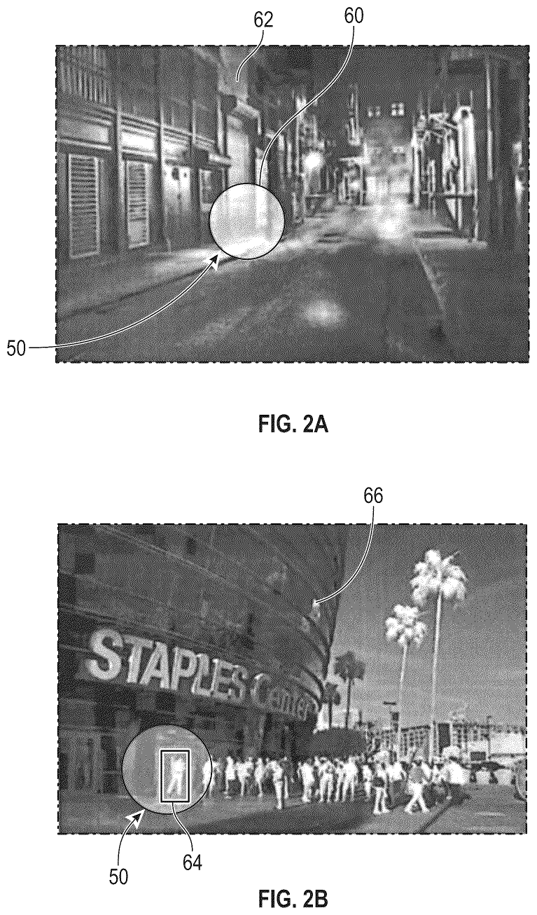

As explained below, the navigation system 10 instructs the spotlight device 22 to shine an infrared spotlight 50 upon a target location that is part of the destination. The target location represents an exact location of the destination that the occupant of the vehicle 12 intends to reach. For example, if the occupant is delivering a package to an industrial building, then the target location may be a bay door 60 of an industrial building 62 (shown in FIG. 2A) for picking up or dropping off packages. As another example, if the occupant is a ride-share driver picking up an individual at a stadium after a baseball game, then the target location is a specific location of the individual 64 located outside of an event venue 66 (shown in FIG. 2B). In this example, the target location is transmitted to the one or more controllers 20 through a ride-sharing application. Merely by way of example, in another embodiment the occupant of the vehicle is delivering a package to a residence, and the target location is a mailbox or a doorway of the residence.

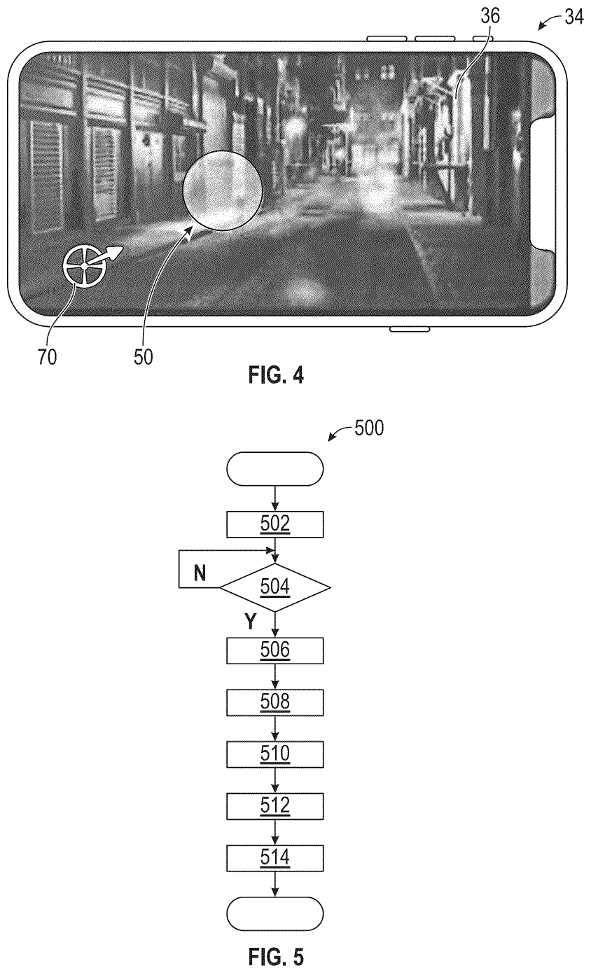

The infrared camera 26 is positioned to capture infrared image data representative of the target location of the destination, where the infrared image data is shown upon the display 32 and is visible to the occupant of the vehicle 12. As shown in FIG. 4 and as explained below, in embodiments the target location of the destination is also shown upon the display 36 of the personal electronic device 34 as well. Referring to FIGS. 1, 2A, and 2B, the infrared spotlight 50 is included as part of the infrared image data captured by the infrared camera 26. Specifically, as seen in FIGS. 2A and 2B, the infrared spotlight 50 is readily and easily seen by the occupant of the vehicle 12. It is to be appreciated that infrared light is used to highlight the target destination instead of visible light because visible light may distract or create an annoyance to other individuals who are in the vicinity of the destination. Furthermore, because infrared light is used, the navigation system 10 may be used during low-visibility conditions, such as nighttime, dusk, smoke, haze, and fog, as well.

Continuing to refer to FIG. 1, the user input device 30 receives user input indicating the destination, where the destination is received by the one or more controllers 20. In an embodiment, the user input also includes the target location that is part of the destination. However, it is to be appreciated that in embodiments the target location is not included as part of the user input, and instead the target location is determined by the one or more controllers 20 instead, which is described below.

Referring to FIG. 1, as the vehicle 12 travels toward the destination, the one or more controllers 20 continuously monitor the location data provided by the GNSS 24 to determine the current location of the vehicle 12. In response to determining the current location of the vehicle 12 is within a threshold distance from the destination, the one or more controllers 20 determine the vehicle 12 is approaching the destination. The threshold distance indicates the vehicle 12 is sufficiently proximate to the destination indicated by the user input to shine the infrared spotlight 50 upon the target location of the destination. In one embodiment, the threshold distance is about 100 meters.

In response to determining the vehicle 12 is within the threshold distance from the destination, in an embodiment the one or more controllers 20 determine the target location of the destination. Specifically, in the event the target location is not included as part of the user input provided by the occupant, the one or more controller 20 may determine the target location based on a description of the destination and the image data captured by the one or more visible light cameras 28. The one or more visible light cameras 28 are positioned to capture image data representative of the target location of the destination. The description of the destination indicates the type of building or area that is the destination such as, for example, if the destination is a residence, commercial building, park, or event venue. The description of the destination also indicates a task associated with the destination. For example, if the occupant is a delivery driver, then the task would be to deliver a package. The one or more controllers 20 determine potential target locations based on the description of the destination. For example, if the description of the destination indicates a residence and the task associated with the destination is delivering a package, then the potential target locations would include a doorway, a mailbox, and the front steps of the residence.

The one or more controllers 20 analyze the image data of the destination based on one of more object recognition algorithms to detect features that signify the potential target locations of the destination. The one or more controllers 20 then select one or the potential target locations as the target location. In an embodiment, the one or more controllers 20 may instruct the display 32 of the vehicle 12 to show the occupant the potential target locations, where the occupant selects the target location by the user input device 30.

In an embodiment where the target location is already known, in response to determining the vehicle 12 is within the threshold distance from the destination, in an embodiment the one or more controllers 20 determine an exact position of the target location of the destination. The exact position of the target location of the destination is expressed in coordinate form (e.g., latitude and longitudinal coordinates) and is determined based on map data and the infrared image data representative of the environment surrounding the vehicle 12 captured by the one or more infrared cameras 26. It is to be appreciated that while the one or more controllers 20 execute one or more object detection algorithms to determine the target location based on the infrared image data, in embodiments the image data captured by the one or more visible light cameras 28 may be used as well to determine the exact position of the target location in order to increase accuracy.

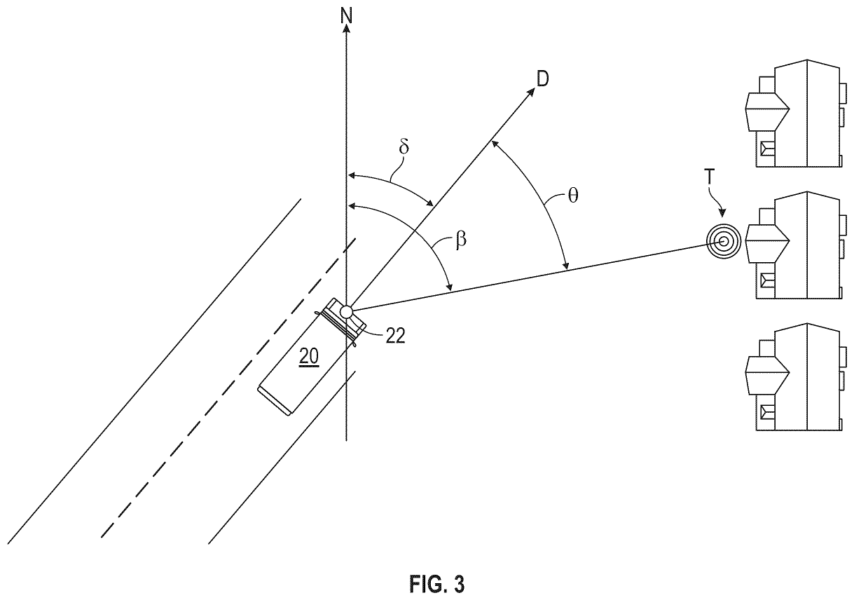

Once the exact position of the target location of the destination is calculated, the one or more controllers 20 then calculate a target angle θ, which is shown in FIG. 3. The target angle θ indicates where the spotlight device 22 directs the beam of infrared light to create the infrared spotlight 50 (shown in FIGS. 2A and 2B) upon the target location. The target angle θ represents an angle measured between a direction of travel D of the vehicle 12 and the target location T of the destination. As seen in FIG. 3, a vehicle heading angle δ is measured between the direction of travel D of the vehicle 12 and the North N, and a true bearing angle β is measured between the North and the target location T. The target angle θ represents a difference between the true bearing angle β and the vehicle heading angle δ.

Referring to FIGS. 1-3, the one or more controllers 20 then instruct the spotlight device 22 to direct the beam of infrared light at the target angle θ towards the target location T (shown in FIG. 3) to create the infrared spotlight 50 (shown in FIGS. 2A and 2B). It is to be appreciated that since the infrared spotlight 50 is infrared light, the infrared spotlight 50 is not visible to humans. The one or more infrared cameras 26 capture infrared image data of the target location of the destination. The one or more controllers 20 then instruct the display 32 to show the infrared image data to the occupant of the vehicle 12. Referring specifically to FIGS. 2A and 2B, the occupant may clearly view the target location of the destination upon the display 32. However, as mentioned above, individuals in the environment surrounding the vehicle 12 are not distracted by the light generated by the spotlight device 22 since the beam of light creating the infrared spotlight 50 is in the infrared spectrum.

FIG. 4 is an illustration of the display 36 of the personal electronic device. The target location of the destination is shown upon the display 36 of the personal electronic device 34. Referring to FIGS. 1 and 4, the occupant may exit the vehicle 12 and walk towards the target location while using the display 36 of the personal electronic device 34 as a guide. In embodiments, an arrow 70 may be used to point the occupant in the direction towards the target location.

FIG. 5 is a process flow diagram illustrating an exemplary method 500 for highlighting the target location of the destination by the infrared spotlight 50 by the navigation system 10. Referring to FIGS. 1 and 5, the method 500 may begin at block 502. In block 502, the one or more controllers 20 receive input indicating the destination and a description of the target location that is part of the destination. As mentioned above, the user input is received by the user input device 30. The method 500 may then proceed to decision block 504.

In decision block 504, the one or more controllers 20 continuously monitor the GNSS 24 to determine the current location of the vehicle 12 until determining the current location of the vehicle 12 is within a threshold distance from the destination. In response to determining the current location of the vehicle 12 is within the threshold distance from destination, the one or more controllers 20 determine the vehicle 12 is approaching the destination, and the method proceeds to block 506.

In block 506, in response to determining the vehicle 12 is approaching the destination, the one or more controllers 20 determine the exact position of the target location of the destination. As mentioned above, the exact position of the target location of the destination is expressed in coordinate form and is determined based on map data and the infrared image data representative of the environment surrounding the vehicle 12 captured by the one or more infrared cameras 26. As mentioned above, the image data captured by the one or more visible light cameras 28 may be used as well. The method 500 may then proceed to block 508.

In block 508, the one or more controllers 20 calculate the target angle θ (FIG. 3), where the target angle θ indicates where the spotlight device 22 directs the beam of infrared light to create the infrared spotlight 50 (shown in FIGS. 2A and 2B) upon the target location. The method 500 may then proceed to block 510.

In block 510, the one or more controllers 20 instruct the spotlight device 22 to direct the beam of infrared light at the target angle θ towards the target location T (shown in FIG. 3) to create the infrared spotlight 50 (shown in FIGS. 2A and 2B). The method 500 may then proceed to block 512.

In block 512, the one or more controllers 20 receive the infrared image data captured by the one or more infrared cameras 26 of the target location of the destination, where the infrared image data includes the infrared spotlight 50. The method 500 may then proceed to block 514.

In block 514, the one or more controllers 20 instruct the display 32 to show the infrared image data to the occupant of the vehicle 12. The method 500 may then terminate.

Referring generally to the figures, the disclosed navigation system provides various technical effects and benefits. Specifically, the disclosed navigation system provides an approach to guide a vehicle occupant to a specific target location that is part of a destination. The infrared spotlight is easily seen by an occupant of the vehicle upon the display of an infotainment device, or on the display of a personal electronic device of the occupant, such as a smartphone. Accordingly, the occupant may clearly and quickly determine the target location of the destination. It is to be appreciated that because the spotlight device generates infrared light, the navigation system may dramatically improve the occupant's ability to locate the target location during low-light conditions.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A navigation system for a vehicle that highlights a target location that is part of a destination, the navigation system comprising:
a spotlight device that generates a beam of infrared light to create an infrared spotlight;
one or more infrared cameras that capture infrared image data representative of the target location of the destination;
a display that renders images upon a screen; and
one or more controllers in electronic communication with the spotlight device, the infrared camera, and the display, wherein the one or more controllers execute instructions to:
determine the vehicle is approaching the destination;
in response to determining the vehicle is approaching the destination, calculate a target angle indicating where the spotlight device directs the beam of infrared light to create the infrared spotlight upon the target location;
receive the infrared image data captured by the one or more infrared cameras of the target location of the destination, where the infrared image data includes the infrared spotlight; and
instruct the display to show the infrared image data captured by the one or more infrared cameras.

2. The navigation system of claim 1, further comprising a user input device in electronic communication with the one or more controllers, wherein the user input device receives user input generated by an occupant of the vehicle.

3. The navigation system of claim 2, wherein the user input indicates the destination, and wherein the one or more controllers determine the target location of the destination.

4. The navigation system of claim 3, wherein the one or more controllers determine an exact position of the target location of the destination based on a description of the destination and the image data captured by the one or more visible light cameras representing the destination.

5. The navigation system of claim 4, further comprising one or more visible light cameras in electronic communication with the one or more controllers, wherein the one or more visible light cameras capture image data representative of the target location of the destination, and wherein the one or more controllers determine the exact position of the target location of the destination based on the image data captured by the one or more visible light cameras representing the destination.

6. The navigation system of claim 2, wherein the user input device is one of the following: a touchscreen, a keyboard, or an audio receiver that captures voice commands spoken by an occupant of the vehicle.

7. The navigation system of claim 1, wherein the target angle represents an angle measured between a direction of travel of the vehicle and the target location of the destination.

8. The navigation system of claim 7, wherein a vehicle heading angle is measured between the direction of travel of the vehicle and the North, a true bearing angle is measured between the North and the target location, and the target angle represents a difference between the true bearing angle and the vehicle heading angle.

9. The navigation system of claim 1, further comprising a global navigation satellite system (GNSS) in electronic communication with the one or more controllers, wherein the GNSS provides location data.

10. The navigation system of claim 9, wherein the one or more controllers execute instructions to:
continuously monitor the location data provided by the GNSS to determine a current location of the vehicle;
compare the current location of the vehicle with the destination; and
in response to determining the current location of the vehicle is within a threshold distance from the destination, determine the vehicle is approaching the destination.

11. The navigation system of claim 1, wherein the spotlight device is one of the following: a motorized pivoting infrared spotlight, a fixed-position matrix spotlight including a plurality of infrared light-emitting diodes (LEDs), and LiDAR.

12. The navigation system of claim 1, wherein the destination is represented by one of the following: a street address and location coordinates.

13. The navigation system of claim 1, wherein the one or more controllers are in wireless communication with a personal electronic device associated with an occupant of the vehicle.

14. The navigation system of claim 13, wherein the target location of the destination is shown upon a display of the personal electronic device.

15. A method for highlighting a target location of a destination by an infrared spotlight by a navigation system for a vehicle, the method comprising:
determining, by one or more controllers, the vehicle is approaching the destination;
in response to determining the vehicle is approaching the destination, calculating, by the one or more controllers, a target angle indicating wherein a spotlight device directs a beam of infrared light to create an infrared spotlight upon the target location;
receiving, by the one or more controllers, infrared image data captured by one or more infrared cameras of the target location of the destination, wherein the infrared image data includes the infrared spotlight; and
instructing, by the one or more controllers, a display to show the infrared image data captured by the one or more infrared cameras.

16. A navigation system for a vehicle that highlights a target location that is part of a destination, the navigation system comprising:
a spotlight device that generates a beam of infrared light to create an infrared spotlight;
one or more infrared cameras that capture infrared image data representative of the target location of the destination;
a display that renders images upon a screen; and
one or more controllers in electronic communication with the spotlight device, the infrared camera, and the display, wherein the one or more controllers execute instructions to:
determine the vehicle is approaching the destination;
in response to determining the vehicle is approaching the destination, calculate a target angle indicating wherein the spotlight device directs the beam of infrared light to create the infrared spotlight upon the target location, wherein the target angle represents an angle measured between a direction of travel of the vehicle and the target location of the destination;
receive the infrared image data captured by the one or more infrared cameras of the target location of the destination, wherein the infrared image data includes the infrared spotlight; and
instruct the display to show the infrared image data captured by the one or more infrared cameras.

17. The navigation system of claim 16, further comprising a user input device in electronic communication with the one or more controllers, wherein the user input device receives user input generated by an occupant of the vehicle.

18. The navigation system of claim 17, wherein the user input indicates the destination, and wherein the one or more controllers determine the target location of the destination.

19. The navigation system of claim 18, wherein the one or more controllers determine an exact position of the target location of the destination based on a description of the destination and the image data captured by the one or more visible light cameras representing the destination.

20. The navigation system of claim 19, further comprising one or more visible light cameras in electronic communication with the one or more controllers, wherein the one or more visible light cameras capture image data representative of the target location of the destination, wherein the one or more controllers determine the exact position of the target location of the destination based on the image data captured by the one or more visible light cameras representing the destination.
